(19) United States
(12) Patent Application Publication
(10) Pub. No.: US 2024/0092001 A1
(43) Pub. Date: Mar. 21, 2024

(54) SPACER WASHER FOR USE WITH INJECTION MOLD

(71) Applicant: PROGRESSIVE COMPONENTS INTERNATIONAL CORPORATION, WAUCONDA, IL (US)

(72) Inventors: Michael Steven Bokich, El Paso, TX (US); Glenn Starkey, Wauconda, IL (US)

(73) Assignee: PROGRESSIVE COMPONENTS INTERNATIONAL CORPORATION, WAUCONDA, IL (US)

(21) Appl. No.: 18/368,351

(22) Filed: Sep. 14, 2023

Related U.S. Application Data
(60) Provisional application No. 63/375,771, filed on Sep. 15, 2022.

(51) Int. Cl. B29C 45/26

(52) U.S. Cl. CPC B29C 45/2606; B29C 2045/277

(57) ABSTRACT

A mold assembly including a spacer positioned or disposed between a back-up plate and a cavity block, the mold assembly, and a method of coupling the back-up plate and the cavity block of the mold assembly using a fastener including the spacer substantially as described above, in order to provide spring-loaded self-adjusting alignment between mating mold inserts.

### CROSS REFERENCE TO RELATED APPLICATION

This application claims the priority benefit of U.S. Provisional Patent Application, Ser. No. 63/375,771, filed on 15 Sep. 2022, and this co-pending U.S. Provisional Patent Application, in its entirety, is hereby incorporated by reference herein and is made a part of this specification, including but not limited to those portions which specifically appear hereinafter.

### BACKGROUND OF THE INVENTION

### Field of the Invention

This invention relates to a spacer of a fastener for coupling a back-up plate to a cavity block of a mold assembly.

### Discussion of Related Art

For decades, manufacturers and people have floated inserts from time-to-time with Belleville springs, which only provides cushion in the Z axis, but the outer diameter does not touch the counterbore so there is not a positioning in the X and Y axis.

### SUMMARY OF THE INVENTION

There are many forces acting on conventional molds that are difficult to factor in during many different manufacturing processes. For example, thermal expansion and platen deviation are two difficult factors.

A radial spring or spacer washer according to this invention can be used to correct a block position to the intended X0 and Y0 location regardless of the platen deviation and/or thermal expansion that occurs every cycle of, for example, a molding machine or another similar manufacturing machine. In some embodiments of this invention, the term radial implies or relates to from or occurring in all directions.

According to some embodiments of this invention, the radial spring or spacer washer is a relatively simple and inexpensive device or apparatus that has at least 3 main or primary functions. First, it is possible to return floating cavities, cores and/or slide faces to the X0 and Y0 positions, relative to or depending upon a designed position, independent of or from the mold and/or the press. Second, the radial spring or spacer washer creates a 0.003 inch gap between the block and the backup plate, which minimizes friction and/or reduces alignment device resistance. Third, the radial spring or spacer washer isolates each block from other components and thus virtually eliminates the effects of thermal expansion and/or platen deviation, which can drastically reduce machine downtime due to wear and/or breakage of machine components.

### BRIEF DESCRIPTION OF THE DRAWINGS

Other advantages of the invention will be readily appreciated as the same becomes better understood by reference to the following detailed description when considered in connection with the accompanying drawings, according to the following drawings.

FIG. 1 is a perspective view of a mold assembly including a back-up plate and cavity block coupled by a fastener.

FIG. 2 is a partial sectional view of the back-up plate coupled to the cavity block by the fastener, and the fastener including a spacer.

FIG. 3A is a partial perspective view of an exemplary fastener arrangement for coupling a back-up plate to a cavity block of a mold assembly, the fastener including a spacer and the cavity block shown in phantom.

FIG. 3B is a partial perspective view of an exemplary fastener arrangement for coupling a back-up plate to a cavity block of a mold assembly, the fastener including a spacer and the back-up plate shown in phantom.

FIG. 4 is an enlarged sectional view of the fastener for coupling the back-up plate to the cavity block of the mold assembly of FIGS. 3A and 3B.

FIG. 5 is a top perspective view of an exemplary configuration of a spacer of the fastener for coupling the back-up plate to the cavity block of a mold assembly.

FIG. 6 is a bottom perspective view of the exemplary configuration of a spacer of the fastener of FIG. 5 for coupling the back-up plate to the cavity block of a mold assembly.

FIG. 7 is a sectional view of the exemplary configuration of a spacer of the fastener of FIGS. 5 and 6 for coupling the back-up plate to the cavity block of a mold assembly.

FIG. 8 is a top perspective view of an exemplary configuration of a spacer of the fastener for coupling the back-up plate to the cavity block of a mold assembly.

FIG. 9 is a sectional view of the exemplary configuration of a spacer of the fastener of FIG. 8 for coupling the back-up plate to the cavity block of a mold assembly.

FIG. 10 is a partial sectional view of an exemplary configuration of a spacer of the fastener positioned about a fastener of a mold assembly.

FIG. 11 is a partial sectional view of the exemplary configuration of the spacer as shown in FIG. 10.

FIG. 12 is an exploded view of an exemplary configuration of a spacer and a fastener.

FIG. 13 is a perspective view of an exemplary configuration of a spacer and a fastener in a molding machine.

FIG. 14 is a sectional view of an exemplary configuration of a spacer and a fastener in a molding machine.

### DETAILED DESCRIPTION OF THE INVENTION

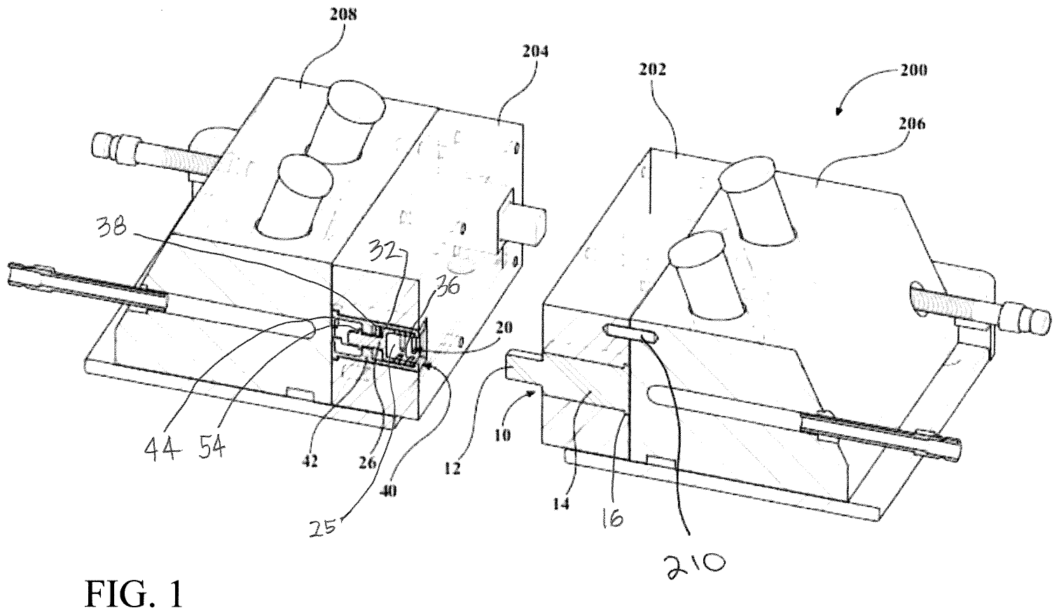

Referring to FIG. 1, a mold assembly 200 is illustrated. The mold assembly 200 may comprise a first half 202 and a second half 204 of a mold pod. The halves 202, 204 of the mold pods may be referred to as cavity blocks 202, 204. Each of the halves 202, 204 of the mold pods may be coupled to a corresponding mold base 206, 208, also referred to as a back-up plate. The halves 202, 204 of the mold pods may be coupled to a corresponding back-up plate 206, 208 by a fastener 210. As used throughout this specification and as described in the claims, the term fastener 210 relates to and can be interchanged with the term dowel pin, pin, connector and/or any other suitable structure that accomplishes the same result of a fastening and/or connecting function. The fastener 210 may comprise or include a spacer 212, which will be described in more detail below. The mold assembly 200 illustrated in FIG. 1 includes a pair of positioning devices 1 to align each of the first half 202 and the second half 204 of the mold pod. The sectioned portion of FIG. 1 illustrates how the tabs 16, 44 extending from the outer surface of the second member 10 and/or the housing 40 secure the corresponding portion of the positioning device 1 in the mold half 202, 204. The protrusion 16, 44 fits within or in the recess of the mold pod when the second member 10 and/or the housing 40 is inserted in the mold opening from the rear. The protrusion 16, 44 prevents the second member 10 and/or the housing 40 from passing all the way through the mold opening. Then, when the halves 202, 204 of the mold pod are coupled to the corresponding back-up plate 206, 208, the back-up plate 206, 208 prevents the second member 10 and/or the housing 40 from sliding out of the halves 202, 204 of the mold pod.

According to some embodiments of this invention, the positioning devices 1 are two alignment locks. In some embodiments of this invention, the protrusion 12 and the void 25 are where the two halves of the positioning devices 1 engage together. In some embodiments of this invention, element reference numeral 14 also points to the positioning device 1 with the protrusion 12 and/or a male alignment lock. In some embodiments of this invention, the positioning device 1 is referred to or known in the industry as a male and female alignment lock.

In some embodiments of this invention, tabs and/or protrusions 16, 44, as shown in FIG. 1, as used throughout this specification and described in the claims, are tabs but in other embodiments of this invention, such as commonly known in the molding industry the tabs are also referred to as heels and/or any other suitable structural element that accomplishes the same result as tabs and/or heels. In some embodiments of this invention, the mold machine design includes needle bearings and a spring-loaded roller cage.

In operation, as the mold halves 202, 204 are brought together, the protrusion 12 is inserted into the void 25 of the first member 20, moving the first member 20 between the first position and the second position. When the protrusion 12 is positioned or disposed within the void 25 and the first member 20 is in the second position, the resilient member 38 is compressed between the ring 32 and the bottom tab 54 of the housing 40. The rollers 36 create a snug fit between the protrusion 12 and the first member 20.

Alternatively, when the mold halves 202, 204 are separated, the protrusion 12 is removed from the void 25 of the first member 20. As the protrusion 12 is removed from the void 25, the resilient member 38 expands as the force applied by the protrusion 12 to the first member 20 is removed, moving the first member 20 between the second position and the first position.

One of the numerous advantages of the positioning device 1 described above over prior mold alignment devices is that the structure and design of this invention allows the present positioning device 1 to be manufactured in a smaller and more compact design while maintaining durability. This allows for the positioning device 1 to be utilized with individual mold pod assemblies, as opposed to prior designs that were coupled to the mold base, which may include multiple mold pod assemblies. By aligning individual mold pod assemblies instead of the entire mold base, this can allow for the mold pod assemblies to hold tighter tolerances and reduce the amount of machining and/or finishing processes required to produce the final part.

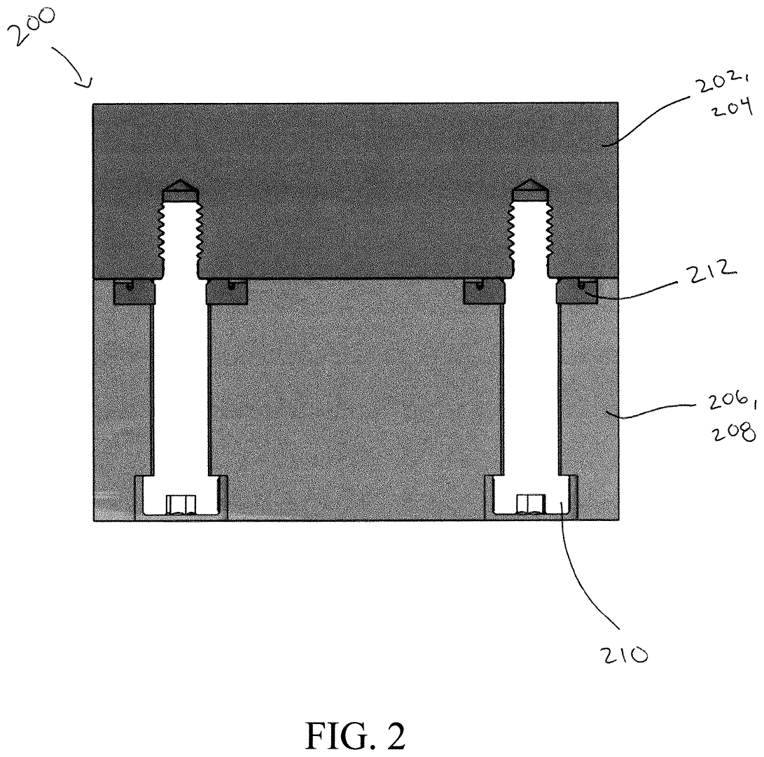

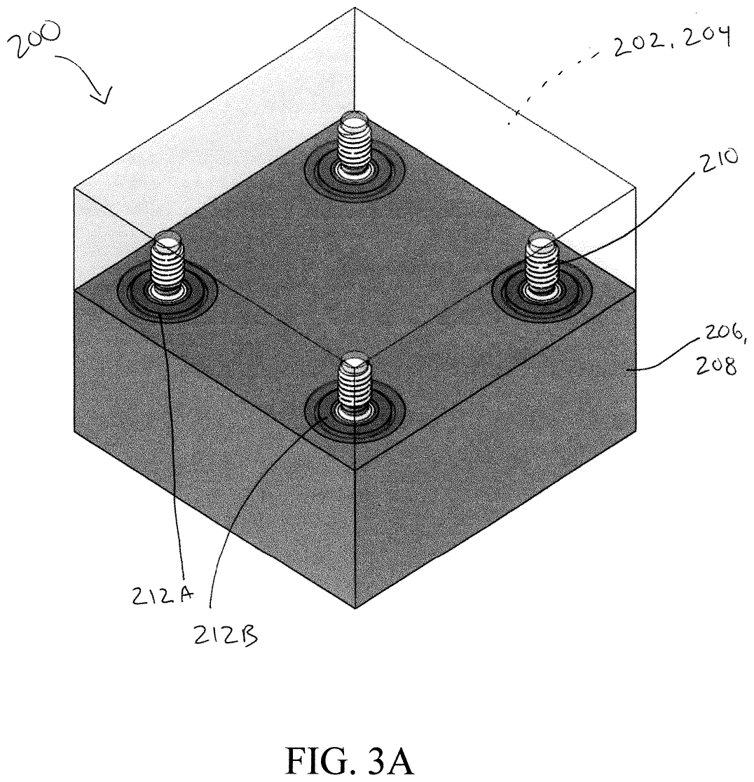

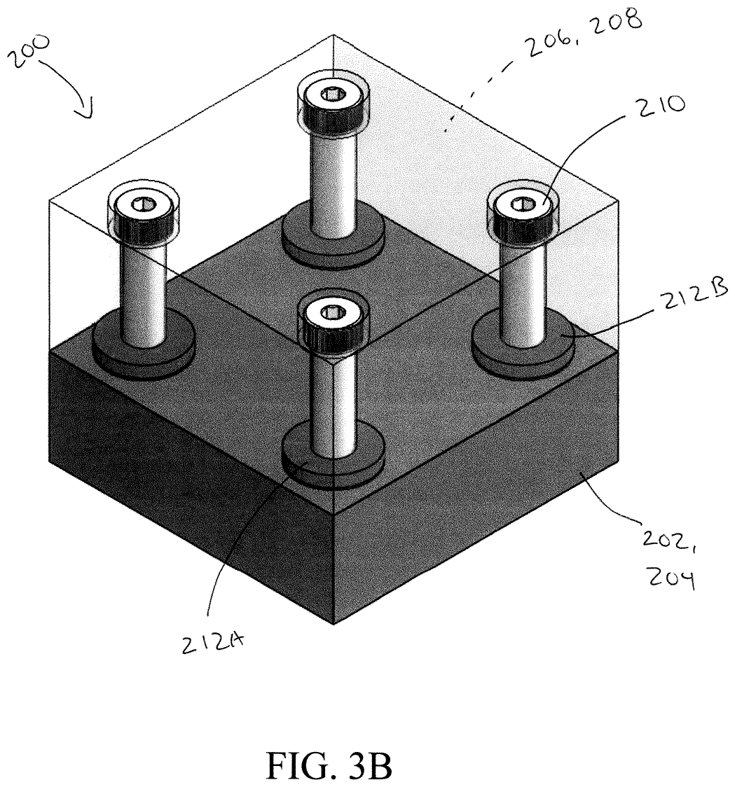

As described above, the halves 202, 204 of the mold pods may be coupled to a corresponding back-up plate 206, 208 by a fastener 210. The fastener 210 may comprise a bolt, screw, or other suitable similar threaded-style fastener. As illustrated in FIGS. 2-4, the threads of the fastener 210 may not cover/extend along the entire length of the fastener 210. For example, the fastener 210 may include a threaded portion and an unthreaded portion, the threaded portion of the fastener 210 may engage reciprocal threads of an aperture in the cavity block 202, 204, and the unthreaded portion may be slidably received within an aperture in the back-up plate 206, 208. While FIGS. 2-4 show the threaded portion engaging reciprocal threads of the cavity block 202, 204 and the unthreaded portion disposed within an aperture of the back-up plate 206, 208, alternative embodiments or arrangements are contemplated, such as the threaded portion of the fastener 210 engaging reciprocal threads of an aperture in the back-up plate 206, 208 and the unthreaded portion disposed within an aperture of the cavity block 202, 204.

The fastener 210 may also comprise or include a spacer 212, which may also be referred to as a washer. The washer or spacer 212 may be formed from a urethane material or similar plastic/rubber polymer. These materials may allow the spacer 212 to be compressed and/or expanded as needed. Furthermore, the material the spacer 212 is formed from may be configured to provide a spring-like or biasing force when compressed and/or moved. For example, as illustrated in FIGS. 2-4, the spacer 212 may encircle or surround the fastener 210 and be disposed between the back-up plate 206, 208 and the cavity block 202, 204. As the fastener 210 is tightened to secure the back-up plate 206, 208 to the cavity block 202, 204, the spacer 212 may be configured to be compressed between the back-up plate 206, 208 and the cavity block 202, 204.

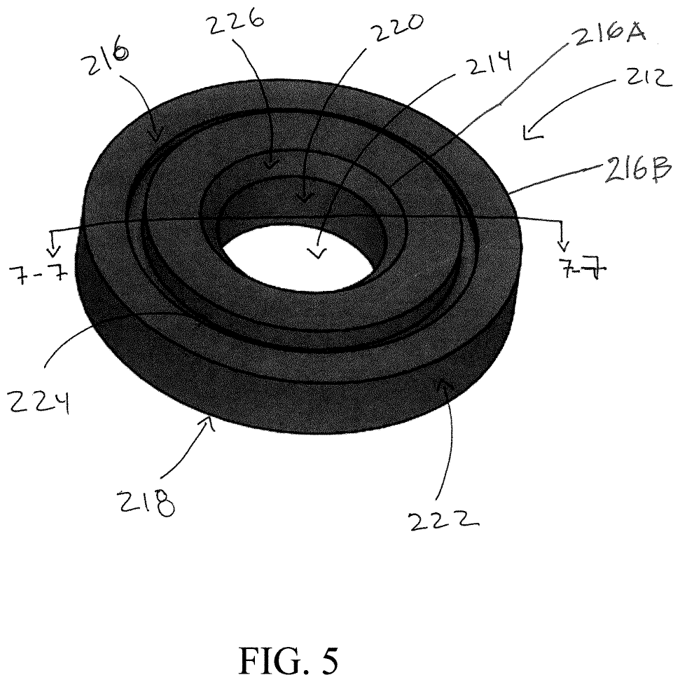

As shown in FIG. 5, the spacer 212 may define an aperture 214 through the spacer 212 and be configured to receive the fastener 210. The spacer 212 may comprise a top surface 216 and an opposing bottom surface 218. An interior surface 220 may define the aperture 214 through the spacer 212, and an outer surface 222 may define the outer diameter of the spacer 212. While the spacer 212 is shown or illustrated as having a generally circular shape, other shapes are contemplated. For example, the spacer 212 may be configured such that the profile of the spacer 212 is a square, a rectangular, a triangular, an oval and/or any other suitable polygonal shape.

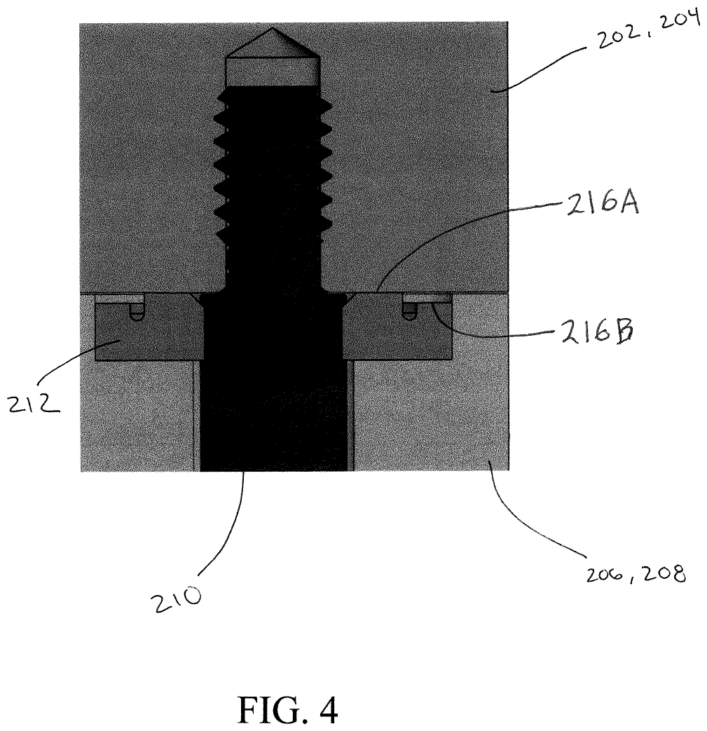

As shown in FIGS. 4, 5 and 7, the top surface 216 of the spacer 212 may define a recess 224 or channel. The recess 224 may define an inner portion 216A and an outer portion 216B of the top surface 216. The inner portion 216A of the top surface 216 is closest to the aperture 214. By contrast, outer portion 216B of the top surface 216 is closest to the outer surface 222. One of the inner portion 216A or the outer portion 216B of the top surface 216 may extend above the surface of the other of the outer portion 216B and the inner portion 216A. For example, as illustrated in FIG. 4, the inner portion 216A of the top surface may extend above the outer portion 216B of the top surface. This may create varying levels of compression of the spacer 212, and/or allow the washer to provide varying levels of spring-like force when compressed. For example, when only the inner portion of the top surface 216 is compressed, the spacer may only provide a limited spring-like force resisting the compression. However, as the spacer 212 is compressed further, to the point of both the inner portion 216A and the outer portion 216B of the top surface being compressed, a greater spring-like force may be exerted by the spacer 212 opposing the compression. The recess 224 may also serve to provide an area or space for the top surface 216 of the spacer 212 to deform as the spacer is compressed. For example, the recess 224 serves as an overflow region for urethane material when the spacer 212 is compressed.

The spacer may also comprise a chamfer or fillet 226 on the top surface 216 of the spacer 212, the chamfer 226 encircles the aperture 214 through the spacer. The chamfer 226 may be configured to provide an area or space around the fastener 210 for the top surface 216 of the spacer 212 to deform as the spacer is compressed.

As illustrated in FIG. 4, the back-up plate 206, 208 defines the aperture or through-hole for receiving the fastener 210. The surface of the back-up plate 206, 208 that engages the cavity block 202, 204 may further define a recess encircling the aperture in the back-up plate 206, 208. The recess may be configured to receive the spacer 210. While the recess is shown as being defined in the surface of the back-up plate 206, 208 that engages the cavity block 202, 204, it is also contemplated that the surface of the cavity block 202, 204 that engages the back-up plate 206, 208 may be configured to define the recess that receives the spacer 212.

The recess in the back-up plate 206, 208 or the cavity block 202, 204 for receiving the spacer 212 may be configured to have a size or diameter that creates a press-fit with the outer surface 222 of the spacer. For example, the recess in the back-up plate 206, 208 or the cavity block 202, 204 may comprise a diameter that creates a press fit with the spacer 212 based on the outer diameter of the spacer 212.

As illustrated in FIG. 4, the inner diameter of the aperture 214 defined by the inner surface 220 of the spacer 212 may be sized to be press fitted on the outer surface or the outer diameter of the fastener 210. For example, as illustrated, the inner diameter of the aperture 214 which is defined by the inner surface 220 may be configured to be press fit on the unthreaded portion of the fastener 210. This may assist in positioning and/or aligning the fastener 210 within the aperture of the back-up plate 206, 208 and/or with aligning the threaded portion of the fastener 210 with the corresponding threaded aperture of the cavity block 202, 204.

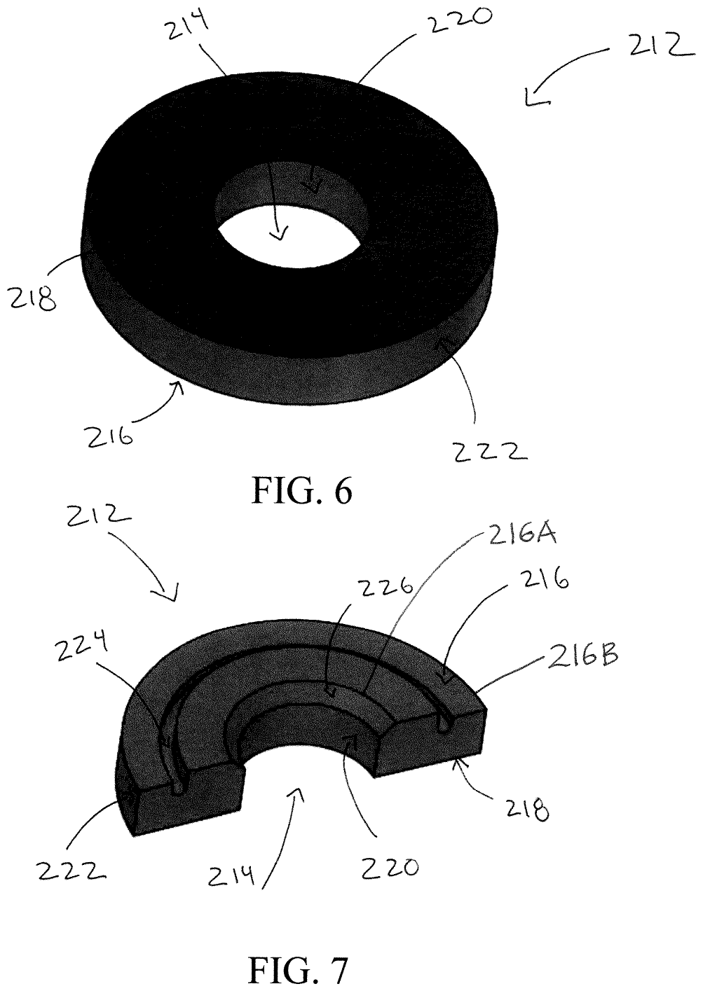

The aperture in the back-up plate 206, 208 may be configured to have an outer diameter greater than an outer diameter of the portion of the fastener 210 that is disposed within the aperture of the back-up plate 206, 208, creating clearance between the outer diameter of the portion of the fastener 210 that is disposed within the aperture of the back-up plate 206, 208 and the outer diameter of the aperture. This will allow the fastener to move laterally, for example, perpendicular to the longitudinal axis of the aperture through the back-up plate 206, 208. While the threaded portion of the fastener 210 fits snuggly in the cavity block 202, 204, the clearance between the fastener 210 and the aperture in the back-up plate 206, 208 in combination with the flexible/compressible spacer 212 allows for some independent movement of the back-up plate 206, 208 relative to or with respect to the cavity block 202, 204. This allows for isolation of each individual cavity block 202, 204 to get perfect alignment with the opposing one of the cavity block 202, 204 to increase and improve tolerances. The press that the mold assembly sits in is not completely accurate and thus there is some play as the two halves of the cavity block 202, 204 come together, so much so that it is possible that the two halves of the cavity block 202, 204 come together differently every time the press compresses the mold assembly together. The spacer 212 described above and shown in the FIGS. 1-7 assists in correcting this issue to improve tolerances and the accuracy of parts created using molds by improving alignment of the two halves of the cavity block 202, 204 as they come together.

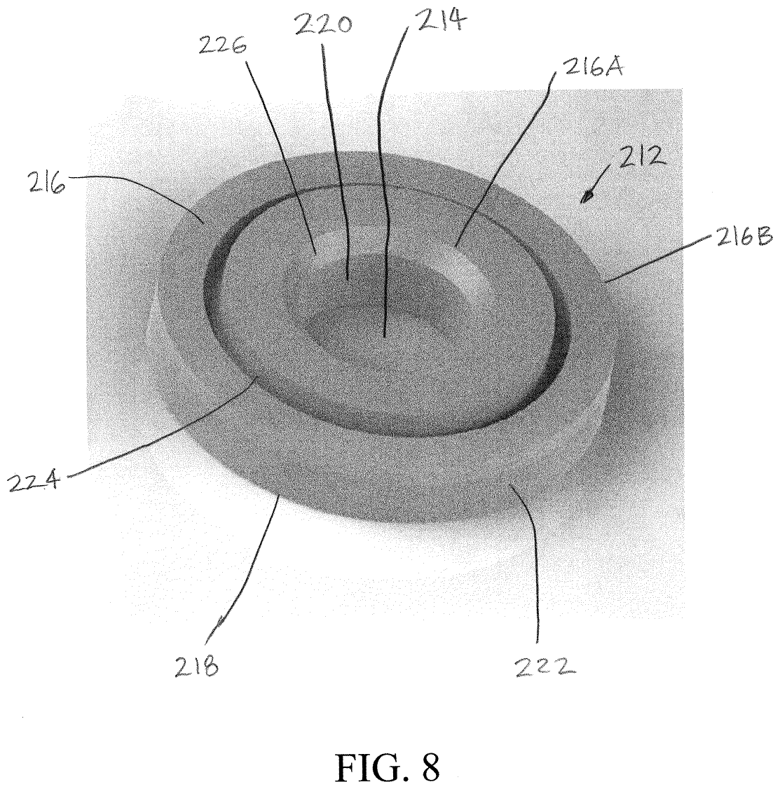

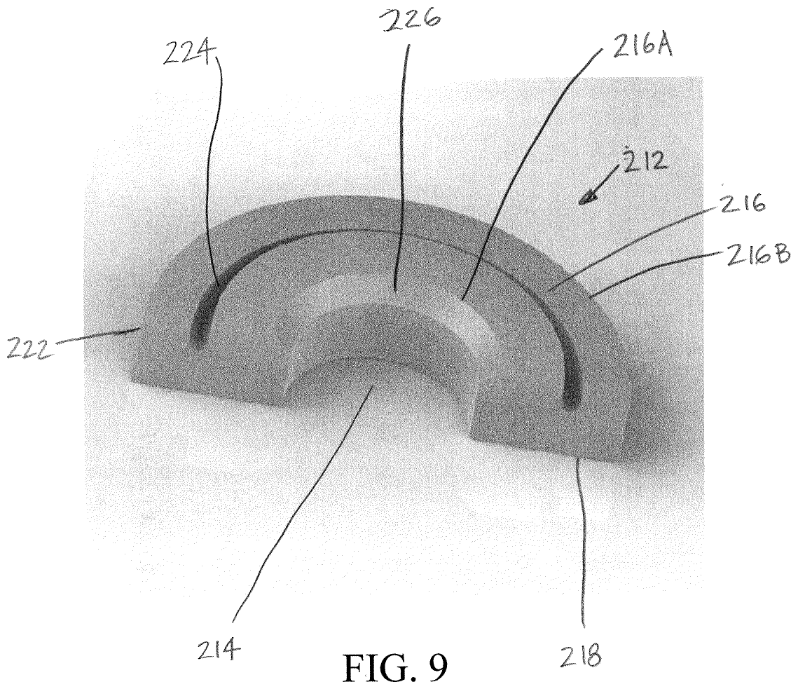

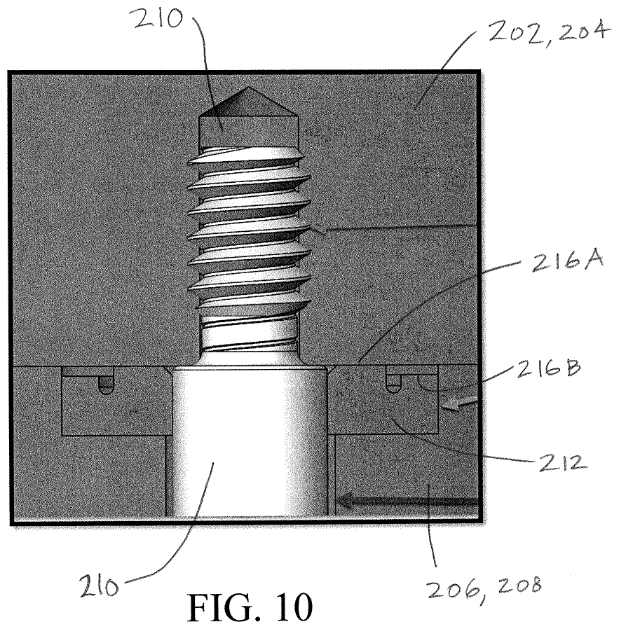

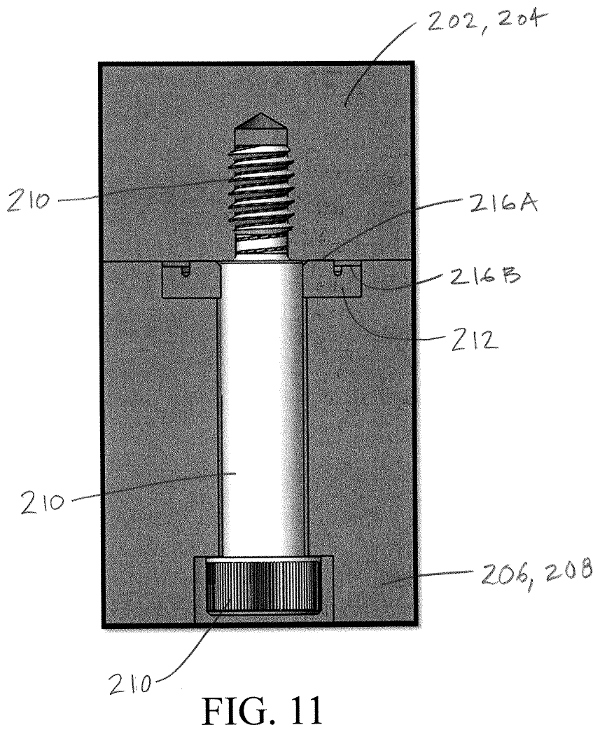

As shown in FIGS. 2-12, for example, according to some embodiments of this invention, the radial spring or spacer washer is described and shown as spacer 212. As used throughout this specification and as described in the claims, the term spacer 212 is intended to be interchangeable with and/or substituted for the term radial spring and/or the term spacer washer. For example, FIGS. 10 and 11 clearly show, according to some embodiments of this invention, the relative positions of spacer 212 mounted on or with respect to fastener 210.

As shown in FIGS. 10 and 11, for example, spacer 212 of this invention requires no machining to the blocks and water and other considerations are not an issue or result in no manufacturing problems. In some embodiments of this invention, screw holes are machined as usual or as normal with only a requirement of a spotface counterbore which is opposite the screw head as shown in FIGS. 10 and 11. In some embodiments of this invention, the required counterbore is not a close tolerance. According to some embodiments of this invention, spacer 212 can have a relatively simple design and dimensions, can be relatively inexpensive and/or require relatively minimal space.

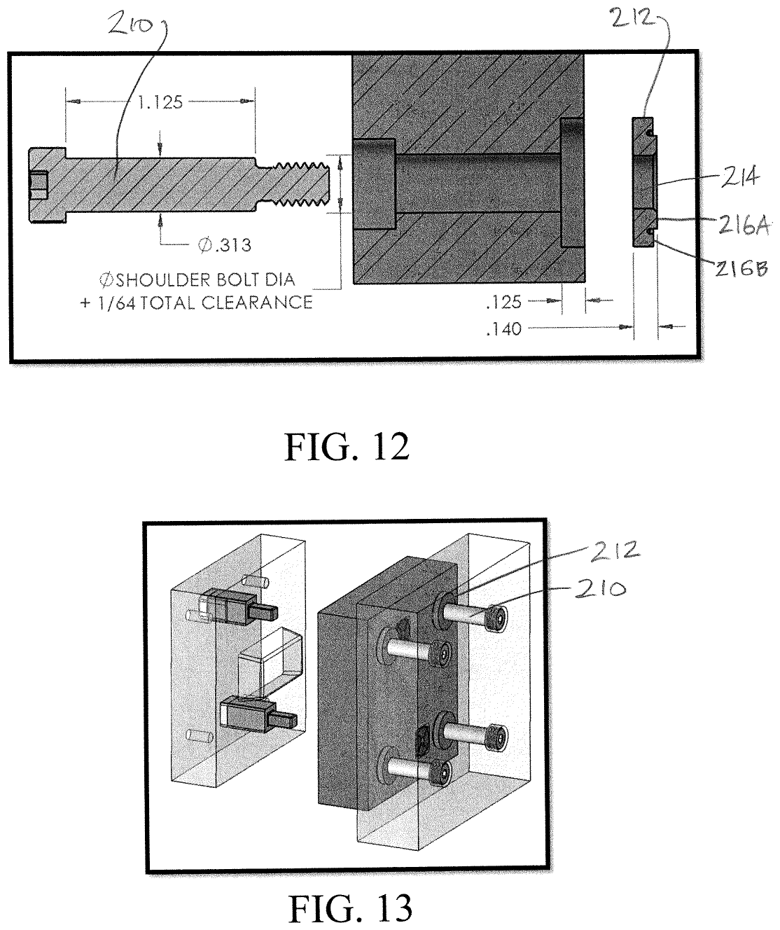

According to some embodiments of this invention, such as shown in the exploded view of FIG. 12, fastener 210 which can be a shoulder bolt, for example, can be mounted, positioned and/or inserted within a plate or other similar structure and pass through spacer 212, with the relative positions of the elements such as also shown in FIG. 11.

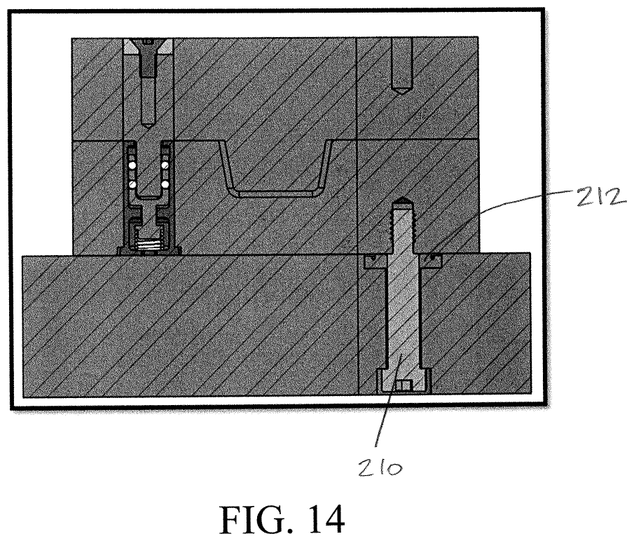

In some embodiments according to this invention, such as shown in FIGS. 13 and 14, many conventional machine molds are relatively unique and there are many different embodiments of or considerations for using various conventional alignment devices or apparatuses. According to some embodiments of this invention, it is possible to use no additional alignment devices or apparatuses because there are no critical shutoffs in the mold or machine mold. In some embodiments of this invention, only spacer 212 is used and because of the dramatic or significant reduction of friction, if the shutoffs permit, no other alignment devices or apparatuses are required. According to some embodiments of this invention, spacer 212 is used with an alignment device, such as a lock device, for ultraprecise alignment for when machine shutoffs are critical and/or there is a relatively high machine volume, and these embodiments can virtually or essentially eliminate wear and/or breakage of certain machine parts, for example, for millions of machine cycles.

According to some embodiments of this invention, when used spacer 212 of this invention can provide absolute minimal or relatively minimal deflection of molding machine elements and/or other similar elements.

In some embodiments of this invention, spacer 212 and/or a lock device can be used on an individual block and/or an entire small mold base. According to some embodiments of this invention, it is possible to eliminate leader pins which makes mold machine real estate available and/or creates valuable mold machine space, for example, for slides, water and/or other machine components. In some embodiments of this invention, the mold machine currently has over 5 million cycles and still retains ultra-precise alignment from the locking device of this invention alone.

In some embodiments of this invention, conventional steel can grow approximately 0.0000065 inch for every degrees Fahrenheit of temperature differential. According to some embodiments of this invention, when mold halves vary by as much as 20° F. and the mold is 30 inches long, the difference in the plate lengths is about 0.004 inch. In some embodiments of this invention, regarding the X and Y axis, the platens do not repeat, even with a new press or mold machine. Many conventional attempts have unsuccessfully solved the problem that spacer 212 of this invention solves relatively reliably, inexpensively and/or simply, particularly while consuming or occupying relatively little valuable mold machine real estate.

According to some embodiments of this invention, the spacer 212 can be used with an actual tool running. The total cost of the mold is about the same as a standard design but precious machine real estate and accuracy were not compromised, all while reducing machine wear. The mold uses 2 locking devices in place of the standard 4 leader pins and 4 parting line locks.

According to some embodiments of this invention, spacer 212 of this invention and a locking device accomplish relatively good results. In some embodiments of this invention, the mold machine can achieve 10 million cycles without wear or damage to critical shutoffs. Standard inspection equipment sometimes cannot detect the relatively small amount of wear so it was done using a 3D white light profilometer. In some embodiments of this invention, where the roller bearing makes contact there is only 0.00001 inch of wear.

According to some embodiments of this invention, a mold insert is bolted to the mold frame and is rigidly affixed. Each time the mold closes, it comes into contact with a mating mold insert which is also rigidly affixed. Because of misalignment that occurs with the injection molding machine, the two inserts bump each cycle, and this can cause mold alignment lock wear and/or damage over time to the mold inserts. In some embodiments of this invention, instead of rigidly affixing with socket head cap screws, there is use of stripper bolts and/or fastener 210, such as shown in FIG. 2. In some embodiments of this invention, there are clearances around the fastener 210 with the backup plate 208. In some embodiments of this invention, the spacer 212 comprises an urethane spring which can serve as a cushion in the Z axis when the mold comes together. This practice is known in the molding industry as floating the inserts, and is not uncommon, and the spacer 210 can be belleville springs.

In some embodiments of this invention, the OD of the spacer 212 and/or the spring is preloaded and presses against the machined counterbore in which it rests, and the ID of the spacer 212 and/or the spring is preloaded and presses against the stripper bolt fastener, and thus holds the insert close to its position in the X and Y axis.

In some embodiments of this invention, when the mold is open, the inserts are held relatively close into position and/or place, and when the mold closes, the two alignment locks find each other's location, and the locks then precisely engage and overpower the less precise spring pressure position. According to some embodiments of this invention, the locks thus are not working hard, because everything is not rigidly bolted into place, battling each other and/or bumping each cycle.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A spacer for aligning a back-up plate and a cavity block of a mold assembly, the spacer comprising: the spacer having an aperture with an inner diameter sized to be press fitted on an unthreaded portion of an outer surface of a fastener, for positioning and/or aligning the fastener within the aperture of the back-up plate and/or for aligning a threaded portion of the fastener with a corresponding threaded aperture of the cavity block.

2. The spacer according to claim 1, wherein the back-up plate or the cavity block has a recess for receiving the spacer, and the recess has a dimension that creates a press-fit with an outer surface of the spacer.

3. The spacer according to claim 2, wherein the recess in the back-up plate or the cavity block has an inner diameter that creates a press fit with an outer diameter of the spacer.

4. The spacer according to claim 1, wherein the spacer has a top surface with an inner portion and an outer portion with a channel between the inner portion and the outer portion.

5. The spacer according to claim 4, wherein the inner portion has an inner biasing force, and the outer portion has an outer biasing force that is different from the inner biasing force.

6. The spacer according to claim 4, wherein in a vertical direction the inner portion is raised above the outer portion.

7. The spacer according to claim 1, wherein the spacer is of a material that provides a spring-like or biasing force when the spacer is compressed and/or moved.

8. The spacer according to claim 1, wherein the spacer has a top surface with a chamfer encircling the aperture.

9. A mold assembly comprising: a spacer disposed between a back-up plate and a cavity block, the spacer having an aperture with an inner diameter sized to be press fitted on an unthreaded portion of an outer surface of a fastener, for positioning and/or aligning the fastener within the aperture of the back-up plate and/or for aligning a threaded portion of the fastener with a corresponding threaded aperture of the cavity block.

10. The mold assembly according to claim 9, wherein the back-up plate or the cavity block has a recess for receiving the spacer, and the recess has a dimension that creates a press-fit with an outer surface of the spacer.

11. The mold assembly according to claim 10, wherein the recess in the back-up plate or the cavity block has an inner diameter that creates a press fit with an outer diameter of the spacer.

12. The mold assembly according to claim 9, wherein the spacer has a top surface with an inner portion and an outer portion with a channel between the inner portion and the outer portion.

13. The mold assembly according to claim 12, wherein the inner portion has an inner biasing force, and the outer portion has an outer biasing force that is different from the inner biasing force.

14. The mold assembly according to claim 12, wherein in a vertical direction the inner portion is raised above the outer portion.

15. The mold assembly according to claim 9, wherein the spacer is of a material that provides a spring-like or biasing force when the spacer is compressed and/or moved.

16. The mold assembly according to claim 9, wherein the spacer has a top surface with a chamfer encircling the aperture.

17. A method for coupling a back-up plate and a cavity block of a mold assembly using a fastener including a spacer for providing a spring-loaded self-adjusting alignment between mating mold inserts, the method including the steps of aligning a back-up plate and a cavity block of a mold assembly with a spacer, the spacer having an aperture with an inner diameter sized to be press fitted on an unthreaded portion of an outer surface of the fastener, for positioning and/or aligning the fastener within the aperture of the back-up plate and/or for aligning a threaded portion of the fastener with a corresponding threaded aperture of the cavity block.

18. The method according to claim 17, wherein the back-up plate or the cavity block has a recess for receiving the spacer, and the recess has a dimension that creates a press-fit with an outer surface of the spacer.

19. The method according to claim 18, wherein the recess in the back-up plate or the cavity block has an inner diameter that creates a press fit with an outer diameter of the spacer.

20. The method according to claim 17, wherein the spacer has a top surface with an inner portion having an inner biasing force, and an outer portion having an outer biasing force that is different from the inner biasing force.
